(19) United States
(12) Patent Application Publication
(10) Pub. No.: US 2006/0121353 A1
(43) Pub. Date: Jun. 8, 2006

(54) Lead-acid battery for automobiles

(76) Inventor: Soon Ki Jang, Anseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/295,290

(22) Filed: Dec. 5, 2005

(30) Foreign Application Priority Data
Dec. 3, 2004 (KR) 10-2004-0101360

(51) Int. Cl. H01M 4/72; H01M 4/74

(52) U.S. Cl. 429/233; 429/153; 429/241

(57) ABSTRACT

Disclosed herein is an automobile lead-acid battery, which comprises a case internally divided into a plurality of separate cells by a plurality of partitions, a plurality of positive plates and a plurality of negative plates alternately interleaved with one another within each of the plurality of cells. A separator is disposed between the positive and negative plates to separate them. An electrolyte is filled in the remaining space of each cell. The positive plate includes an upper frame formed at one side with a lug protruding upwardly, a lower frame positioned in parallel with the upper frame, side frames coupled to both ends of the upper and lower frames to thereby form a square framework with four rounded corners to prevent damage to the separator. A plurality of inner grids is disposed within the square framework and taking a radial shape.

### CROSS REFERENCE TO RELATED APPLICATION

This application claims priority to Korean Application No. 10-2004-0101360, filed on Dec. 3, 2004, the disclosure of which is incorporated herein by reference.

### FIELD OF THE INVENTION

The present invention generally relates to lead-acid batteries for automobiles, and more particularly, to such lead-acid batteries for automobiles of which the structure, the ampere-hour (“AH”) for formation charging and the like of a positive plate (or electrode) and a negative plate (or electrode) are optimally designed, thereby improving battery life as well as reducing battery weight.

### BACKGROUND OF THE RELATED ART

Automobile batteries rely on a secondary (or rechargeable) battery used as an electrical power source for ignition, illumination and so on through the discharging of the battery when starting a car. Also, the battery is re-charged through the electricity produced by the alternator or generator when the car is drive. Currently, lead-acid batteries are most widely used as automobile batteries.

One of the most important components in the lead-acid battery is the pole plate, i.e., the positive and negative plate, which are fabricated by a gravity casting technique and an expanded grid casting technique. According to the gravity casting technique, when a melted alloy made of lead (Pb), calcium (Ca), etc., is poured into a mold of a casting machine positioned at a lower portion by its weight, alloyed lead of high temperature is cooled down by cooling water contained within the mold of the casting machine so as to fabricate a pole plate. According to the expanded grid casting technique, a melted alloy is first cooled down to form a thin coil type strip, and the surface of the strip is cut out into a number of slits at a certain distance by a slitter and then expanded at both ends by an expander, to thereby continuously fabricate a pole plate with diamond-shaped grids formed therein.

The gravity casting method has an advantage in that the inner grid of the pole pate can be configured in various patterns and a side frame can be formed to thereby achieve excellent durability. However, it has a disadvantage in that productivity is lowered due to an intermittent casting process. On the other hand, the expanded grid casting method is advantageous in that the pole plate can be continuously fabricated using the thin coil type strip, thereby increasing productivity. However, it is disadvantageous in that the shape of the inner grid of the pole plate is limited to a diamond shape and a side frame cannot be formed to thereby cause the pole plate to easily be deformed due to an external shock.

The pole plate is commonly subjected to a formation process during the fabrication of the pole plate. This formation process refers to a process in which electrical energy is transformed into chemical energy to store electricity. During the formation of the pole plate, the positive plate is changed into brown-colored porous lead dioxide (PbO₂) electrode to become a stable state, and the negative plate is changed into a gray-colored pure sponge lead (Pb) electrode to cause extremely rapid reaction with oxygen in the air.

When the lead dioxide electrode and the sponge lead electrode is immersed in an electrolyte made of sulfuric acid (H₂SO₄), a certain voltage is generated between the two electrodes by virtue of the electro-chemical reaction. The magnitude of voltage generated varies depending on the AH for formation charging which is an important factor to determine the performance of the battery. Assuming that a theoretical AH for formation charging of the pole plate needed to generate the required voltage of 2.041 V is 100%, the pole plate is actually designed to have a AH for formation charging of approximately 250% to 260% in view of loss of the AH for formation charging due to electrical resistance.

### SUMMARY OF THE INVENTION

It is an object of the present invention to provide a lead-acid battery for automobiles, which is designed to improve the durability of the battery as well as reduce the weight of the battery by optimizing the above-mentioned performance-determining factors through several times experiments and sample fabrication.

To accomplish the above object, according to the present invention, a lead-acid battery for automobiles comprises a case internally divided into a plurality of separate cells by plural partitions, a plurality of positive plates and a plurality of negative plates alternately interleaved with one another within each of the plurality of cells. A separator is disposed between the positive and negative plates in such a fashion that each plate of one polarity is separated from the adjacent plate of opposite polarity by the separator, and an electrolyte is filled in the remaining space of each cell. The positive plate includes: an upper frame formed at one side with a lug protruding upwardly therefrom; a lower frame positioned in parallel with the upper frame; side frames coupled to both ends of the upper and lower frames to thereby form a square framework four corners of which are rounded in order to prevent damage of the separator; and a plurality of inner grids which are disposed within the square framework and take a radial shape, the positive plate having a thickness of 1.55 mm to 1.65 mm.

Further, the positive plate may be preferably fabricated by a gravity casting method.

Also preferably, the negative plate may include: an upper frame formed at one side with a lug protruding upwardly therefrom; a lower frame positioned in parallel with the upper frame; and a plurality of inner grids which are disposed between the upper frame and the lower frame and take a diamond shape, the negative plate having a thickness of 1.55 mm to 1.65 mm.

The negative plate may be preferably fabricated by an expanded grid casting method.

Preferably, the positive and negative plates have a AH for formation charging of 220% to 240%.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a front view illustrating a positive plate of a lead-acid battery for automobiles according to the present invention; and

FIG. 2 is a front view illustrating a negative plate of a lead-acid battery for automobiles according to the present invention.

### DETAILED DESCRIPTION OF THE PREFERRED EMBODIMENT

Reference will now be made in detail to the preferred embodiment of the present invention with reference to the attached drawings.

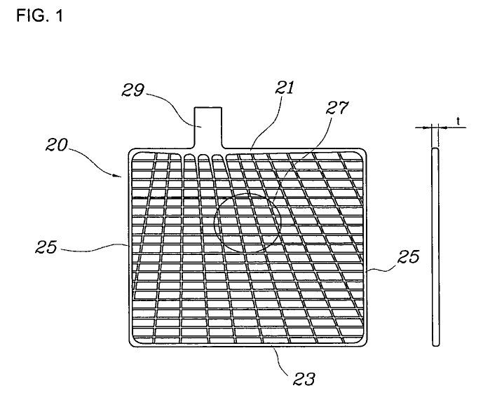

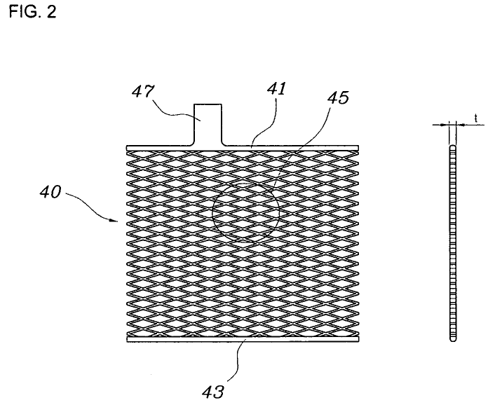

FIG. 1 is a front view illustrating a positive plate of a lead-acid battery for automobiles according to the present invention, and FIG. 2 is a front view illustrating a negative plate of a lead-acid battery for automobiles according to the present invention.

The most important technical feature of the present invention resides in the configuration of a positive plate, which will be described hereinafter with reference to FIG. 1.

Referring to FIG. 1, a positive plate 20 according to the present invention includes an upper frame 21 formed at one side with a lug protruding upwardly therefrom, a lower frame 23 positioned in parallel with the upper frame 21, and side frames 25 coupled to both ends of the upper and lower frames 21 and 23 to thereby form a square framework. On the upper frame 21, there is a lug 29 attached, which serves as a traveling path for the electrons collected through the electro-chemical reaction. The lug 29 may be positioned at the center of the upper frame 21, near the center of the upper frame 21 (see FIG. 1), or at the edge of the upper frame along a longitudinal direction of the upper frame. Among these, the lug is most favorably positioned at the center of the upper frame for the collection of electrons, but is typically positioned near the center of the upper frame 21 in view of the battery assembly.

Side frames 25 are formed on the positive plate 20. If this side frame 25 is omitted, resistance to upward and downward impact exerted on the positive plate 20 is weakened, and hence the positive plate 20 may be crushed due to an external impact generated when driving the car, which contributes to deterioration in the battery performance. According to the expanded grid casting method as described above, since a coil type strip advances continuously to form a pole plate, it is impossible to fabricate side frames. Thus, the gravity casting method is required to fabricate the side frames for the positive plate 20.

Further, in the structure of the positive plate 20, the square framework composed of the upper frame 21, the lower frame 23 and the side frames 25 have four corners which are rounded. These are aimed at preventing damage of the separator disposed between the pole plates 20 and 40 (not shown) owing to the sharp corners of the pole plates when the positive and negative plates 20 and 40 collide against the separator due to an external impact. If the separator is impaired, there is a risk that the positive plate 20 and the negative plate 40 will be short-circuited. Therefore, short-circuiting can be prevented by rounding the four corners of the positive plate 20.

In addition, the positive plate 20 according to the present invention is configured such that it has a radial-shaped inner grid structure. The inner grid structure of the positive plate 20 may take a radial shape shown in FIG. 1, a diamond shape shown in FIG. 2 or a rectangle shape (not shown). Among these, the inner grids of the positive plate 20 are preferably formed in the radial shape to achieve increased electron collection efficiency, lowered electrical resistance, and excellent electrical performance. Besides these, the radial shaping of the inner grids enhance charge acceptance as well as prolonging the lifespan of the battery. The expanded grid casting method as mentioned above enables only a diamond-shaped inner grid structure. Hence, this embodiment of the present invention adopts the gravity casting method in order to make the inner grid structure of the positive plate 20 in the radial shape.

As described above, preferably in this embodiment, the side frames 25 are formed for the positive plate 20 and the inner grids of the positive plate are made in the radial shape by the gravity casting method. This means that the present invention adopts the gravity casting mode of two pole plate fabricating methods, which are currently commercialized. It is also possible to make the side frames 25 and the radial shaped inner grids through other methods. Moreover, according to the gravity casting method, thermal resistance and corrosion resistance are improved, thereby further battery life.

According to the present invention, the most specific feature of the positive plate 20 resides in its thickness. One of the objects of the present invention is to reduce the weight of the battery. This object is accomplished by decreasing the thickness of the pole plates. Conventionally, the thickness of the positive plate is typically 1.7 mm. The optimal thickness of the positive plate 20 in this embodiment of the present invention exhibits at least the same performance as that of the conventional plate, in which the optimal thickness of the positive plate 20 is within a range between 1.55 mm and 1.65 mm.

When the positive plate 20 has a thickness of less than 1.55 mm, its AH for formation charging is very low, i.e., the amount of lead dioxide (PbO₂), which is an active material attached on the positive plate is very small, so that the required voltage (2.041V) is not generated, thus deteriorating battery performance. On the other hand, when the positive plate 20 has a thickness of more than 1.65 mm, a much larger amount of the active material than needed to generate the required voltage is attached on the positive plate 20 through a formation process, which is not economical. Consequently, when the positive plate 20 has a thickness of 1.55 mm to 1.65 mm, it is possible to optimally utilize the active material needed to generate the required voltage, thereby ensuring the highest battery efficiency.

In FIG. 2, the negative plate 40 according to the present invention includes an upper frame 41, a lower frame 43, and a plurality of inner grids 45. The upper frame 41 is formed at one side with a lug 47 protruding upwardly therefrom. The lower frame 43 is positioned in parallel with the upper frame 41, and the plurality of inner grids 45 are disposed between the upper frame 41 and the lower frame 43. Each of the inner grids 45 is made in the diamond shape.

The negative plate 40 may be configured such that side frames are provided for the negative plate 40 and the inner grids 45 are formed in a radial shape as in the positive plate 20. To this end, however, the negative plate 40 should be fabricated by the gravity casting method. Nevertheless, in the case where all the pole plates are prepared by the gravity casting method, their productivity is lowered due to a limitation of the gravity casting method involving an intermittent process. Therefore, the embodiments of the present invention employ the expanded grid casting method only in case of fabrication of the negative plate 40 in order to compensate for decreased productivity according to fabrication of the positive plate 20. In other words, the embodiments of the present invention adopt the gravity casting method for fabrication of the positive plate 20 and the expanded grid casting method for fabrication of the negative plate 40, respectively, in view of battery lifespan, electrical performance and productivity of a pole plate.

The thickness of the negative plate 40 is preferably within a range between 1.55 mm and 1.65 mm similarly to the thickness of the positive plate 20. The reason for this is that the thickness of the pole plate has no relation with a fabrication method, and even in the case where the negative plate 40 is made in a range of the above thickness for the sponge lead, which is an active material is most efficiently used to generate the required voltage. The critical significance of such a thickness range of the negative plate 40 is identical to that of the positive plate 20.

Lastly, according to the present invention, it is possible to reduce the AH for formation charging of the positive and negative plates 20 and 40, so that the manufacturing cost can also be decreased. The formation process of the pole plate is intended to transform electrical energy into chemical energy to thereby store electricity. 100311 Owing to this energy transformation occurring during the formation of the pole plate, the positive plate 20 is changed into brown-colored porous lead dioxide (PbO₂) electrode to become stable, and the negative plate 40 is changed into a gray-colored pure sponge lead (Pb) electrode. 100321 As can be seen from the above background part, assuming that a theoretical AH for formation charging of the pole plate necessary for generating the required voltage of 2.041V is 100%, the pole plate is actually designed to have a AH for formation charging of approximately 250% to 260% in view of electric loss or the like. 100331 However, according to the present invention, the positive and negative plates 20 and 40 can be most efficiently used by optimally designing the shape and the thickness of the inner grids thereof. As a result, if the AH for formation charging of the positive and negative plates 20 and 40 is within a range between 220% and 240%, the required voltage can also be generated. That is, the reduction of the thickness of the positive and negative plates 20 and 40 allows one or more pole plate to be additionally installed within the same cell space. Consequently, the density of a pole plate within the same cell space is increased, which enables generation of the required voltage even with a lower AH for formation charging. Although the density of the pole plates is increased, if the AH for formation charging is less than 220%, the pole plates lack of the resolute amount of the active material, such that the required voltage is not generated. On the other hand, if the AH for formation charging is more than 240%, the pole plates have the excessive amount of active material attached thereto, which is not economical in terms of the manufacturing cost.

The preferred embodiment of the present invention will now be described in more detail hereinafter.

### EXAMPLE AND COMPARATIVE EXAMPLE

The present invention is intended to reduce the manufacturing cost, the weight and the like of the battery, and improve battery life while exhibiting at least the same performance as that of the conventional battery through optimal design of the configuration of the battery as described above. In order to demonstrate this fact, the following performance test has been carried out.

In this embodiment, the performance test was performed using a lead-acid battery of a model named “GLBAL 4500R” manufactured by Global Battery Co., Ltd and installed in EQUUS which is a kind of passenger cars manufactured by HYUNDAI MOTOR COMPANY. This lead-acid battery employed a positive plate and a negative plate both of which had been fabricated by the expanded grid casting method. The positive and negative plates had a diamond-shaped inner grid structure, and substantially had a AH for formation charging of 250% without side frames. On the other hand, a lead-acid battery according to the present invention was a lead-acid battery that employed the positive plate having radial shaped inner grids and side frames which had been fabricated by the gravity casting method. The lead-acid battery employed the negative plate which had been fabricated by the conventional expanded grid casting method. In this case, the positive and negative plates were made to have a thickness of 1.60 mm and a AH for formation charging of 230% reduced as compared to the conventional one. The performance test used two kinds of lead-acid batteries as mentioned above in order to measure voltage (V), Cold Cranking Ampere (CCA), Reserve Capacity (RC), 5-Hour Rate (5HR) Capacity, charge acceptance, durability, weight and so on, all of which are performance requirements of the battery. The measurement results are given in the following Table.

TABLE

| | | | | 5HR | Charge | | |
|---|---|---|---|---|---|---|---|
| | Voltage(V) | CCA(A) | RC(min) | capacity | acceptance | Durability | Weight |
| Comparative Example | 12 | 630 | 130 | 64 | Good | Not bad | 19.5 |
| Example | 12 | 640 | 130 | 65 | Good | Good | 18.6 |

As can be seen from the Table that, in the present invention, weight is reduced by 0.9 kg and battery life is improved by providing side frames to the positive plate, as compared to the conventional prior art, while exhibiting the same performance as the conventional prior art. For reference, the CCA refers to a starting current at 18 degree C., which means the current required for smoothly starting a car's engine in the winter season. The RC represents a measure of the time (in minutes) during which a lead-acid battery can deliver 25 amps at 25 degree C. and continuously discharge until terminal voltage reaches 10.5 V. The 5HR capacity represents a measure of the capacity for the time (5 hours) during which a lead-acid battery can continuously discharge until terminal voltage reaches 10.5 V.

As described above, according to a lead-acid battery for automobiles of the present invention, the durability of the battery is further improved and its weight is reduced while maintaining the same performance as that of the conventional battery, thus contributing to an improvement of fuel consumption rate. Furthermore, the AH for formation charging of the battery is reduced, thereby leading to a reduction in the manufacturing cost.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A lead-acid battery for automobiles, which comprises a case internally divided into a plurality of separate cells by a plurality of partitions, a plurality of positive plates and a plurality of negative plates alternately interleaved with one another within each of the plurality of cells, a separator disposed between the positive and negative plates in such a fashion that each plate of one polarity is separated from the adjacent plate of opposite polarity by the separator, and an electrolyte filled in the remaining space of each cell, wherein the positive plate includes: an upper frame formed at one side with a lug protruding upwardly therefrom; a lower frame positioned in parallel with the upper frame; side frames coupled to both ends of the upper and lower frames to thereby form a square framework four corners of which are rounded in order to prevent damage of the separator; and a plurality of inner grids which are disposed within the square framework and take a radial shape, the positive plate having a thickness of 1.55 mm to 1.65 mm.

2. The lead-acid battery of claim 1, wherein the positive plate is fabricated by a gravity casting method.

3. The lead-acid battery of claim 1, wherein the negative plate includes: an upper frame formed at one side with a lug protruding upwardly therefrom; a lower frame positioned in parallel with the upper frame; and a plurality of inner grids which are disposed between the upper frame and the lower frame and take a diamond shape, the negative plate having a thickness of 1.55 mm to 1.65 mm.

4. The lead-acid battery of claim 3, wherein the negative plate is fabricated by an expanded grid casting method.

5. The lead-acid battery of claim 1, wherein the positive and negative plates have an AH for formation charging of 220% to 240%.
